(19) United States
(12) Patent Application Publication
(10) Pub. No.: US 2025/0349830 A1
(43) Pub. Date: Nov. 13, 2025

(54) NEGATIVE ELECTRODE MATERIAL, NEGATIVE ELECTRODE PLATE, AND BATTERY

(71) Applicant: ZHUHAI COSMX BATTERY CO., LTD., Zhuhai (CN)

(72) Inventors: Ruinian LI, Zhuhai (CN); Jiachen XUE, Zhuhai (CN); Hui WANG, Zhuhai (CN)

(73) Assignee: ZHUHAI COSMX BATTERY CO., LTD., Zhuhai (CN)

(21) Appl. No.: 19/274,916

(22) Filed: Jul. 21, 2025

Related U.S. Application Data
(63) Continuation of application No. PCT/CN2024/078274, filed on Feb. 23, 2024.

(30) Foreign Application Priority Data
Mar. 4, 2023 (CN) 202310199614.6

(51) Int. Cl. H01M 4/36; H01M 4/02; H01M 4/38; H01M 4/587

(52) U.S. Cl. CPC H01M 4/364; H01M 4/386; H01M 4/587; H01M 2004/021

(57) ABSTRACT

A negative electrode material includes a silicon-carbon particle, the silicon-carbon particle has a hollow structure, the hollow structure includes a cavity and a shell surrounding the cavity, the shell includes a silicon-carbon layer; a mass content of silicon in the silicon-carbon particle ω and a ratio of a radius of the cavity to a radius of the silicon-carbon particle a satisfy

$$ω \leq \frac{{a}^{3}}{1.05 \times ( 1 - {a}^{3} )} .$$

The negative electrode material of the present disclosure can effectively alleviate the expansion of silicon material during battery cycling, improve the cycling performance of the battery, and effectively enhance the conductivity of the negative electrode material.

### CROSS-REFERENCE TO RELATED APPLICATIONS

This application is a continuation of International Application No. PCT/CN2024/078274, filed on Feb. 23, 2024, which claims priority to Chinese Patent Application No. 202310199614.6, filed on Mar. 4, 2023. Both of the aforementioned applications are hereby incorporated by reference in their entireties.

### TECHNICAL FIELD

The present disclosure relates to the field of batteries, specifically to a negative electrode material, a negative electrode plate including the negative electrode material, and a battery including the negative electrode material.

### BACKGROUND

With the rapid development of lithium-ion battery technologies, the application of lithium-ion batteries in portable electronic devices such as laptops and smartphones has become increasingly widespread, and the demand for higher energy density in batteries has also increased.

Currently, graphite blended with silicon is the main measure to improve the energy density of batteries. However, silicon materials have poor conductivity and significant volume expansion during cycling. Typically, silicon is compounded with carbon to form silicon-carbon materials to alleviate volume expansion, improve conductivity, and enhance the cycling performance of batteries, but no significant improvement has been observed.

Thus, it is crucial to discover a battery that balances both energy density and cycling performance.

### SUMMARY

The object of the present disclosure is to overcome the aforementioned problems in the conventional technology by providing a negative electrode material, a negative electrode plate including the negative electrode material, and a battery including the negative electrode material. The negative electrode material of the present disclosure includes a silicon-carbon particle with a hollow structure. A mass content of silicon in the silicon-carbon particle and a ratio of a cavity radius of the hollow structure to a radius of the silicon-carbon particle have a specific relationship, which effectively mitigates the expansion of silicon material during battery cycling, improves the cycling performance of the battery and conductivity of the negative electrode material.

A first aspect of the present disclosure provides a negative electrode material, including a silicon-carbon particle with a hollow structure, where the hollow structure includes a cavity and a shell surrounding the cavity, the shell includes a silicon-carbon layer, and a mass content of silicon in the silicon-carbon particle ω (unit: %) and a ratio of a radius of the cavity to a radius of the silicon-carbon particle a (unit: %) satisfy

$$ω \leq \frac{{a}^{3}}{1.05 \times ( 1 - {a}^{3} )} .$$

A second aspect of the present disclosure provides a negative electrode plate, the negative electrode plate includes the negative electrode material according to the first aspect of the present disclosure.

A third aspect of the present disclosure provides a battery, the battery includes the negative electrode material according to the first aspect of the present disclosure and/or the negative electrode plate according to the second aspect of the present disclosure.

Based on the foregoing technical solutions, the present disclosure has at least the following advantages compared with the conventional technology.

Firstly, the negative electrode material of the present disclosure includes a silicon-carbon particle with a hollow structure, which can alleviate expansion of silicon.

Secondly, the negative electrode material of the present disclosure includes a silicon-carbon particle, which includes a shell and a cavity surrounded by the shell. And a mass content of silicon in the silicon-carbon particle and a ratio of a radius of the cavity to a radius of the silicon-carbon particle have a specific relationship, which can further alleviate volume expansion of silicon.

An endpoint and any value of the ranges disclosed herein are not limited to the exact ranges or values, and these ranges or values shall be understood to include values close to these ranges or values. For a numerical range, one or more new numerical ranges may be obtained in combination with each other between endpoint values of respective ranges, between endpoint values of respective ranges and individual point values, and between individual point values, and these numerical ranges should be considered as specifically disclosed herein.

### BRIEF DESCRIPTION OF THE DRAWINGS

FIG. 1 is a schematic diagram of a hollow structure in the present disclosure.

FIG. 2 is an energy spectrum element distribution pattern of silicon-carbon particles in an example of the present disclosure.

FIG. 3a is an X-ray diffraction (XRD) pattern of a silicon-carbon particle in an example of the present disclosure.

FIG. 3b is an XRD pattern of a silicon-carbon material in a comparative example of the present disclosure.

FIG. 4 is a schematic diagram of a hollow structure in the present disclosure.

FIG. 5 is a scanning electron microscope (SEM) image of silicon-carbon particles prepared in Example 1 of the present disclosure.

FIG. 6 is an SEM image of silicon-carbon materials prepared in Comparative Example 1 of the present disclosure.

FIG. 7 is a point scan result of the energy spectrum element distribution pattern of silicon-carbon particles prepared in Example 1 of the present disclosure.

FIG. 8 is a point scan result of the energy spectrum element distribution pattern of silicon-carbon particles prepared in Example 5 of the present disclosure.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

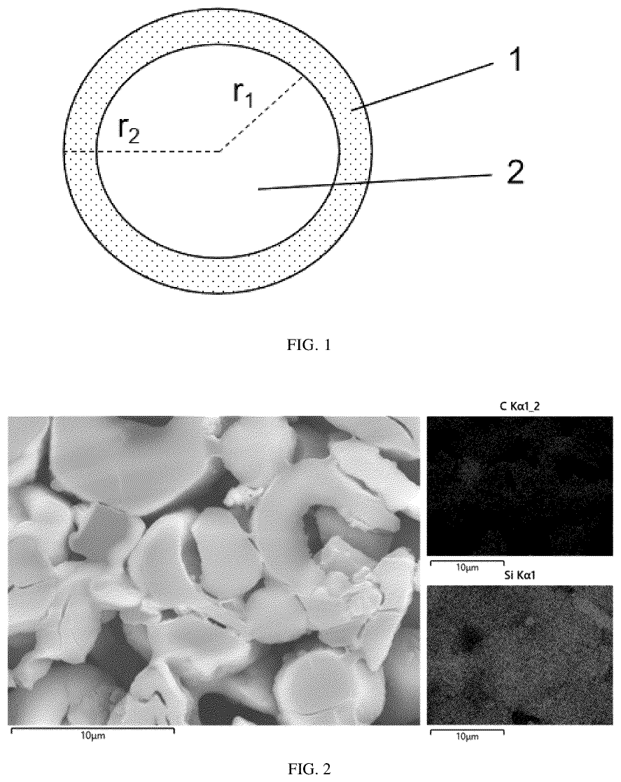

A first aspect of the present disclosure provides a negative electrode material, the negative electrode material includes a silicon-carbon particle, the silicon-carbon particle has a hollow structure, and the hollow structure may include a cavity and a shell surrounding the cavity. As shown in FIG. 1, it is a schematic diagram of a hollow structure in the present disclosure, in which the hollow structure includes a cavity 2 and a shell 1 surrounding the cavity 2; where r₁ and r₂ marked by dashed lines in FIG. 1 refer to a radius of the cavity and a radius of the silicon-carbon particle, respectively.

In the present disclosure, the shell includes a silicon-carbon layer.

In an example, the shell is the silicon-carbon layer.

In the present disclosure, a mass content of silicon in the silicon-carbon particle ω (unit: %) and a ratio of a radius of the cavity to a radius of the silicon-carbon particle a (unit: %) satisfy

$$ω \leq \frac{{a}^{3}}{1.05 \times ( 1 - {a}^{3} )} .$$

Taking Example 1 of the present disclosure as an example to illustrate the above relationship, the mass content of silicon in the silicon-carbon particle ω is 13%, a is 49.26%, and

$$\frac{{a}^{3}}{1.05 \times ( 1 - {a}^{3} )}$$

is calculated as 0.13, satisfying the condition

$$ω \leq \frac{{a}^{3}}{1.05 \times ( 1 - {a}^{3} )} .$$

Conventional silicon-carbon materials will expand and contract with the charge and discharge cycles of the battery when used as negative electrode materials, which leads to the gradual failure of the silicon-carbon materials. It has been found that when the silicon-carbon particle has the hollow structure, the hollow structure can alleviate the expansion of silicon. Further, when the ratio of the radius of the cavity of the hollow structure to the radius of the silicon-carbon particle has a specific relationship with the mass content of silicon in the silicon-carbon particle, it can further alleviate the expansion of silicon, thereby significantly improving the cycle performance of the battery.

In the present disclosure, the mass content of silicon in the silicon-carbon particle ω may range from 0.01% to 90%, for example, 0.01%, 0.05%, 0.1%, 0.5%, 1%, 5%, 10%, 15%, 20%, 25%, 30%, 35%, 40%, 45%, 50%, 55%, 60%, 65%, 70%, 75%, 80%, 85%, or 90%.

In an example, the mass content of silicon in the silicon-carbon particle ω ranges from 5% to 20%.

It has been found that when the mass content of silicon in the silicon-carbon particle is within a specific range, the battery can balance both energy density and cycle performance.

In the present disclosure, the mass content of silicon in the silicon-carbon particle ω can be tested by conventional methods in the art, such as using a carbon-sulfur analyzer.

In the present disclosure, the radius of the cavity may range from 0.05 μm to 14.5 μm, for example, 0.05 μm, 0.1 μm, 0.5 μm, 1 μm, 2 μm, 3 μm, 4 μm, 5 μm, 6 μm, 7 μm, 8 μm, 9 μm, 10 μm, 11 μm, 12 μm, 13 μm, 14 μm, or 14.5 μm.

In the present disclosure, the ratio of the radius of the cavity (r1) to the radius of the silicon-carbon particle (r2) a may range from 0.3% to 97%, for example, 0.3%, 0.5%, 1%, 5%, 10%, 15%, 20%, 25%, 30%, 35%, 40%, 45%, 50%, 55%, 60%, 65%, 70%, 75%, 80%, 85%, 90%, 95%, or 97%.

In an example, the radius of the cavity (r1) ranges from 0.5 μm to 4 μm.

In the present disclosure, the radius of the silicon-carbon particle and the radius of the cavity can be tested by conventional methods in the art, for example, by a scanning electron microscopy (SEM). In the field of view of the SEM image of the silicon-carbon particle, 20 silicon-carbon particles are randomly selected, and the radii of the silicon-carbon particles and the radii of the cavity are measured using a measuring tool, and the average value is taken. When the silicon-carbon particles and the cavity are standard circles in the SEM image, the radius of the silicon-carbon particle and the radius of the cavity are the radius of the circle; when the silicon-carbon particle and the cavity are non-standard circles (for example, ellipses) in the SEM image, the radius of the silicon-carbon particle and the radius of the cavity are the equivalent radius of a standard circle with the same area as the non-standard circle.

In the present disclosure, a carbon in the silicon-carbon particle includes a porous carbon.

In the present disclosure, a pore diameter of the porous carbon may range from 0.001 nm to 50 nm, for example, 0.001 nm, 0.005 nm, 0.01 nm, 0.05 nm, 0.1 nm, 0.2 nm, 0.3 nm, 0.4 nm, 0.5 nm, 0.6 nm, 0.7 nm, 0.8 nm, 0.9 nm, 1 nm, 5 nm, 10 nm, 15 nm, 20 nm, 25 nm, 30 nm, 35 nm, 40 nm, 45 nm, or 50 nm.

In an example, the pore diameter of the porous carbon ranges from 0.005 nm to 20 nm.

In an example, the pore diameter of the porous carbon ranges from 0.01 nm to 10 nm.

It has been found that when the pore diameter of the porous carbon is within a specific range, it has a good mitigating effect on the volume expansion of silicon materials.

In the present disclosure, the pore diameter of the porous carbon can be tested by conventional methods in the art, for example, referring to the national standard GB/T 19587-2017; or using the equipment Micromeritics TristarII3020.

In an example, the porous carbon includes micropores and/or mesopores.

It has been found that the porous carbon has abundant micropores and/or mesopores, and loading silicon materials in the micropores and/or mesopores of the porous carbon can not only form an interconnected conductive network, enhancing the electronic connectivity between silicon materials, but also reduce the agglomeration of silicon materials, and provide buffer space for the volume expansion of silicon materials.

In the present disclosure, five points are randomly selected on the silicon-carbon layer of the silicon-carbon particle, a ratio of a mass of silicon to a mass of carbon at each point is mₙ, an average value of the ratio of the mass of silicon to the mass of carbon at the five points is m₀, and mₙ and m₀ satisfy

$$\vert \frac{{m}_{n} - {m}_{0}}{{m}_{0}} \vert \times 100 \% \leq 50 \% ,$$

where n is 1, 2, 3, 4, or 5; for example,

$$\vert \frac{{m}_{n} - {m}_{0}}{{m}_{0}} \vert \times 100 \%$$

equal to 1%, 5%, 10%, 15%, 20%, 25%, 30%, 35%, 40%, 45%, or 50%.

In an example, five points are randomly selected on the silicon-carbon layer of the silicon-carbon particle, the ratio of the mass of silicon to the mass of carbon at each point is mₙ, the average value of the ratio of the mass of silicon to the mass of carbon at the five points is m₀, and mₙ and m₀ satisfy

$$\vert \frac{{m}_{n} - {m}_{0}}{{m}_{0}} \vert \times 100 \% \leq 35 \% ,$$

where n is 1, 2, 3, 4, or 5.

In an example, five points are randomly selected on the silicon-carbon layer of the silicon-carbon particle, the ratio of the mass of silicon to the mass of carbon at each point is mₙ, the average value of the ratio of the mass of silicon to the mass of carbon at the five points is m₀, and mₙ and m₀ satisfy

$$\vert \frac{{m}_{n} - {m}_{0}}{{m}_{0}} \vert \times 100 \% \leq 25 \% ,$$

where n is 1, 2, 3, 4, or 5.

In the present disclosure, the mass of silicon and the mass of carbon at random points on the silicon-carbon layer of the silicon-carbon particle can be obtained by performing energy spectrum element distribution analysis on the silicon-carbon particle and performing point scanning on the energy spectrum element distribution map of the silicon-carbon particle obtained from the test, specifically: in the energy spectrum element distribution map of the silicon-carbon particle, finding the location of the silicon-carbon layer, randomly selecting 5 points from the location of the silicon-carbon layer, performing point scanning, and then performing element analysis on each point to obtain the mass content of silicon and the mass content of carbon at each point, where the point scanning area is approximately a circular area with a diameter of 300 nm.

As shown in FIG. 7, a point scanning result of the energy spectrum element distribution map of the silicon-carbon particles prepared in an example of the present disclosure, it can be seen from the figure that the ratio of the mass of silicon to the mass of carbon at the five points is within a small range, indicating that the distribution of silicon and carbon in the silicon-carbon layer of the silicon-carbon particles is relatively uniform.

It has been found that by randomly selecting five points on the silicon-carbon layer of the silicon-carbon particle and taking the average value of the ratio of the mass of silicon to the mass of carbon at the five points, the difference between the ratio of the mass of silicon to the mass of carbon at each of the five random points and the average value. When the ratio of the difference between the five random points and the average value is within a certain range, the distribution of silicon and carbon is more uniform, which can enhance the conductive network between silicons and between silicon and carbon, enhance the conductivity of the silicon-carbon particle, and thus enhance the rate performance of the battery.

In the present disclosure, a silicon in the silicon-carbon particle is uniformly distributed in the pores of the porous carbon, as shown in FIG. 2, an energy spectrum element distribution pattern of silicon-carbon particles in an example of the present disclosure, it can be seen from FIG. 2 that the silicon and carbon are uniformly distributed.

In the present disclosure, a median particle size Dv50 of the silicon-carbon particle may range from 2 μm to 30 μm, for example, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, or 30 μm.

In an example, the median particle size Dv50 of the silicon-carbon particle ranges from 5 μm to 10 μm.

In the present disclosure, the median particle size Dv50 of the silicon-carbon particle can be tested by conventional methods in the art, such as a laser particle size analyzer.

It has been found that when the median particle size Dv50 of the silicon-carbon particle is within a certain range, the kinetic performance of the silicon-carbon particle is better, the side reactions with the electrolyte solution are smaller, and the operation during the coating process is easier.

In the present disclosure, a thickness of the silicon-carbon layer may range from 0.5 μm to 5 μm, for example, 0.5 μm, 1 μm, 2 μm, 3 μm, 4 μm, or 5 μm.

In the present disclosure, a ratio of the thickness of the silicon-carbon layer to the radius of the silicon-carbon particle may range from 3% to 98%, for example, 3%, 5%, 10%, 15%, 20%, 25%, 30%, 35%, 40%, 45%, 50%, 55%, 60%, 65%, 70%, 75%, 80%, 85%, 90%, 95%, or 98%.

It has been found that when the ratio of the thickness of the silicon-carbon layer to the radius of the silicon-carbon particles is within a specific range, it can effectively alleviate the expansion of the silicon-carbon particle.

In an example, the thickness of the silicon-carbon layer ranges from 1 μm to 4.5 μm.

It has been found that when the thickness of the silicon-carbon layer is within a specific range, it can effectively alleviate the expansion of the silicon-carbon particle.

In the present disclosure, the thickness of the silicon-carbon layer refers to a thickness of a single layer of the silicon-carbon layer.

In the present disclosure, the thickness of the silicon-carbon layer can be tested by conventional methods in the art, such as SEM. In the SEM image of the silicon-carbon particles, 20 silicon-carbon particles are randomly selected, and the thickness of the silicon-carbon layer is measured using a measuring tool (at least five points are randomly selected for each silicon-carbon particle, and the average value is taken), and the average value is taken.

In the present disclosure, a silicon in the silicon-carbon particle includes a amorphous silicon.

It has been found that when the silicon is amorphous silicon, the volume change of the silicon during the battery cycle is smaller, and thus the cycle performance of the battery is better.

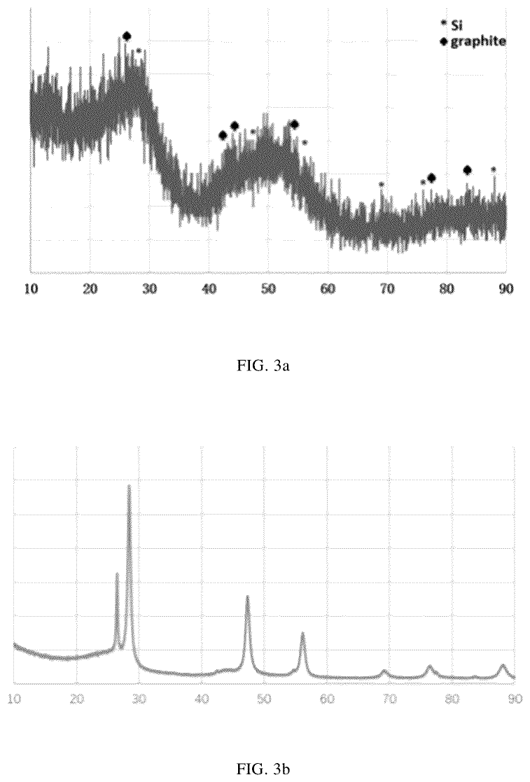

In an example, the silicon in the silicon-carbon particle is amorphous silicon. As shown in FIG. 3a, an XRD pattern of a silicon-carbon particle in an example of the present disclosure, FIG. 3b is an XRD pattern of a silicon-carbon material in a comparative example of the present disclosure. It can be seen from comparing with the two figures that the silicon in the silicon-carbon particle of the present disclosure includes amorphous silicon.

In the present disclosure, a median particle size Dv50 of the silicon may range from 0.01 nm to 150 nm, for example, 0.01 nm, 0.05 nm, 0.1 nm, 0.5 nm, 1 nm, 2 nm, 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, or 150 nm.

In an example, the median particle size Dv50 of the silicon ranges from 1 nm to 40 nm.

In an example, the median particle size Dv50 of the silicon ranges from 2 nm to 10 nm.

It has been found that when the median particle size Dv50 of the silicon in the silicon-carbon particle is controlled within a certain range, it can effectively reduce the volume expansion of the silicon, thereby effectively improving the cycle performance of the battery.

In the present disclosure, the median particle size Dv50 of the silicon can be measured by conventional methods in the art, for example, the battery is discharged to 0% SOC, disassembled to extract the negative electrode plate, and a cross-section of the negative electrode plate is polished using an argon-ion milling machine, then, a transmission electron microscope (TEM) is used to select at least 20 silicon particles in the field of view, and the particle size of each silicon particle is measured and averaged. Where, when the silicon particles appear as standard circles in the field of view, the particle size is the diameter of that standard circle; when the silicon particles are non-standard circles (for example, elliptical), the particle size is the equivalent diameter of a standard circle with the same area as the non-standard circle.

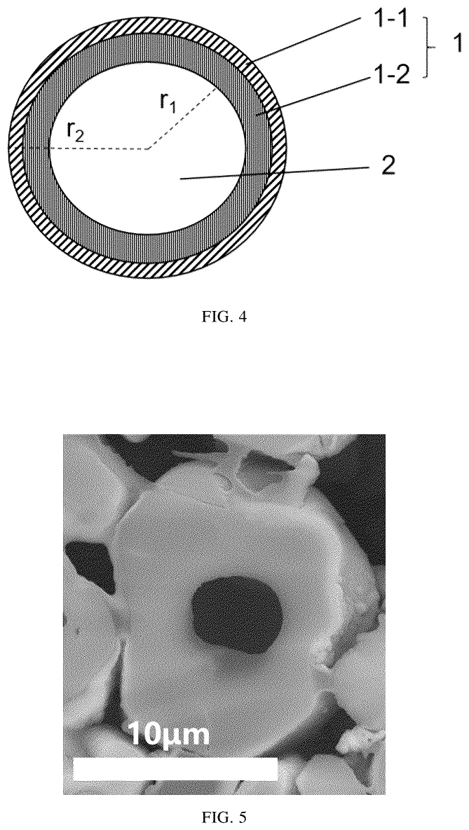

In the present disclosure, the shell may further include a coating layer on the outer surface of the silicon-carbon layer; as shown in FIG. 4, it is a schematic diagram of a hollow structure in the present disclosure. In FIG. 4, a shell 1 includes a silicon-carbon layer 1-2 and a coating layer 1-1 on the outer surface of the silicon-carbon layer 1-2, where r₁ and r₂ marked by dashed lines in FIG. 4 refer to a radius of the cavity and a radius of the silicon-carbon particle, respectively.

It has been found that setting a coating layer on the outer surface of the silicon-carbon layer can protect the silicon-carbon layer, further improving the cycle performance and rate performance of the battery.

In the present disclosure, a thickness of the coating layer may range from 20 nm to 300 nm, for example, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 150 nm, 200 nm, 250 nm, or 300 nm.

It has been found that when the thickness of the coating layer is within a specific range, the cycle performance and rate performance of the battery can be improved.

In the present disclosure, a ratio of the thickness of the coating layer to the radius of the silicon-carbon particle may range from 0.1% to 30%, for example, 0.1%, 0.3%, 0.5%, 1%, 5%, 10%, 15%, 20%, 25%, or 30%.

It has been found that when the ratio of the thickness of the coating layer to the radius of the silicon-carbon particle is within a specific range, the cycle performance and rate performance of the battery can be improved.

In an example, the thickness of the coating layer ranges from 50 nm to 70 nm.

In the present disclosure, the thickness of the coating layer refers to a thickness of a single layer of the coating layer.

In the present disclosure, the thickness of the coating layer can be tested by conventional methods in the art, such as SEM. In the SEM image of the silicon-carbon particle, 20 silicon-carbon particles are randomly selected, and the thickness of the coating layer is measured using a measuring tool (at least five points are randomly selected for measurement on the coating layer of each silicon-carbon particle, and the average value is taken), and the average value is taken. In the present disclosure, the coating layer may include a carbon layer.

In an example, the coating layer is a carbon layer.

In the present disclosure, a conductivity of the silicon-carbon particle may range from 10 S/cm to 500 S/cm, for example, 10 S/cm, 20 S/cm, 30 S/cm, 40 S/cm, 50 S/cm, 60 S/cm, 70 S/cm, 80 S/cm, 90 S/cm, 100 S/cm, 150 S/cm, 200 S/cm, 250 S/cm, 300 S/cm, 350 S/cm, 400 S/cm, 450 S/cm, or 500 S/cm.

In an example, the conductivity of the silicon-carbon particle ranges from 20 S/cm to 320 S/cm.

In the present disclosure, the conductivity of the silicon-carbon particle can be tested according to the method of GB/T 24533-2019.

It has been found that when the conductivity of the silicon-carbon particle is within a certain range, the rate performance of the battery can be further improved.

In the present disclosure, a specific surface area of the silicon-carbon particle may range from 0.5 m²/g to 25 m²/g, for example, 0.5 m²/g, 1 m²/g, 2 m²/g, 3 m²/g, 4 m²/g, 5 m²/g, 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, 20 m²/g, 21 m²/g, 22 m²/g, 23 m²/g, 24 m²/g, or 25 m²/g.

In the present disclosure, the specific surface area of the silicon-carbon particle can be tested according to the method of GB/T 24533-2019.

It has been found that when the specific surface area of the silicon-carbon particle is within a specific range, the battery has better cycle performance and rate performance.

In the present disclosure, a true density of the silicon-carbon particle may range from 1 g/cm³ to 3 g/cm³, for example, 1 g/cm³, 1.5 g/cm³, 2 g/cm³, 2.5 g/cm³, or 3 g/cm³.

In an example, the true density of the silicon-carbon particle ranges from 1.1 g/cm³ to 2.2 g/cm³.

In the present disclosure, the true density of the silicon-carbon particle can be tested according to the method of GB/T 24533-2019.

It has been found that when the true density of the silicon-carbon particle is within a specific range, the battery has superior energy density and cycle performance.

The negative electrode active material of the present disclosure includes a silicon-carbon particle with a hollow structure, which can effectively alleviate the expansion of silicon during battery cycling, improve the conductivity of the silicon-carbon particle, and thereby enhance the cycling performance and rate performance of the battery.

The present disclosure further provides a method for preparing the silicon-carbon particle, the method at least includes: depositing a silicon material by vapor deposition in a porous carbon with a hollow structure.

In the present disclosure, the porous carbon with the hollow structure can be obtained commercially or prepared.

In an example, the porous carbon with the hollow structure is prepared, the preparation method at least includes: performing a first sintering of a biomass porous carbon material with a hollow structure in an inert atmosphere.

In the present disclosure, the biomass porous carbon material with the hollow structure can be selected from conventionally used biomass porous carbon materials with a hollow structure, for example, selected from pollen or starch.

It has been found that the composition of the biomass porous carbon material includes carbon, hydrogen, and oxygen elements, where carbon element serves as the skeleton and occupies a large mass proportion in the biomass porous carbon material. Sintering the biomass porous carbon material in an inert atmosphere can yield conductive carbon material with high yield; this biomass porous carbon material has a hollow shell structure with abundant micropores and mesopores. After high-temperature carbonization, the resulting porous carbon has a suitable specific surface area for loading silicon particles.

In the present disclosure, the inert atmosphere can be selected from conventionally used inert atmospheres, for example, selected from nitrogen, argon, helium, neon, and krypton, or a combination thereof.

In the present disclosure, a temperature of the first sintering may range from 400° C. to 1300° C., for example, 400° C., 500° C., 600° C., 700° C., 800° C., 900° C., 1000° C., 1100° C., 1200° C., or 1300° C. A time of the first sintering may range from 1 h to 24 h, for example, 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h, or 24 h.

In the present disclosure, the vapor deposition can be performed in a vapor deposition furnace, that is, placing the porous carbon with the hollow structure in a first vapor deposition furnace.

In the present disclosure, a condition for vapor deposition may includes: introducing a silicon source and a protective gas.

In an example, the silicon source includes at least one of silane, disilane, dichlorosilane, trichlorosilane, or silicon tetrachloride.

In the present disclosure, a flow rate of the silicon source may range from 0.5 L/min to 5 L/min, for example, 0.5 L/min, 1 L/min, 2 L/min, 3 L/min, 4 L/min, or 5 L/min.

In an example, the protective gas includes at least one of nitrogen, argon, helium, neon, or krypton.

In the present disclosure, a temperature of the vapor deposition may range from 300° C. to 1000° C., for example, 300° C., 400° C., 500° C., 600° C., 700° C., 800° C., 900° C., or 1000° C. A time of the vapor deposition may range from 0.25 h to 12 h, for example, 0.25 h, 0.5 h, 1 h, 2 h, 3 h, 4 h, 5 h, 6 h, 7 h, 8 h, 9 h, 10 h, 11 h, or 12 h.

In the present disclosure, the method for preparing the silicon-carbon particle can further include: after vapor deposition of the silicon material, performing a conductive carbon coating.

In the present disclosure, the conductive carbon coating may include vapor deposition coating.

The vapor deposition coating at least includes the following method: placing the material after vapor deposition of the silicon material in a second vapor deposition furnace, introducing a carbon source and nitrogen, and performing a carbon coating.

In the present disclosure, the carbon source can include methane and/or acetylene.

In the present disclosure, a temperature of the carbon coating may range from 350° C. to 1000° C., for example, 350° C., 400° C., 500° C., 600° C., 700° C., 800° C., 900° C., or 1000° C. A time of the carbon coating may range from 0.5 h to 12 h, for example, 0.5 h, 1 h, 2 h, 3 h, 4 h, 5 h, 6 h, 7 h, 8 h, 9 h, 10 h, 11 h, or 12 h.

The method for preparing the silicon-carbon particle provided in the present disclosure has an easily controllable process route. Through vapor deposition, silicon material can be uniformly distributed in porous carbon material. By controlling the flow rate of the silicon source during vapor deposition, as well as the time and temperature of vapor deposition, the silicon material can be further uniformly distributed in the porous carbon material. Additionally, the use of biomass carbon material simplifies the treatment process and is environmentally friendly.

A second aspect of the present disclosure provides a negative electrode plate, which includes the negative electrode material according to the first aspect of the present disclosure.

The negative electrode plate includes a negative electrode current collector and a negative electrode coating layer located on at least one side surfaces of the negative electrode current collector. The negative electrode coating layer includes the negative electrode material according to the first aspect of the present disclosure.

The negative electrode coating layer includes additives conventionally, such as a conductive agent and a binder.

In an example, the negative electrode coating layer includes the negative electrode material, the conductive agent, and the binder.

The conductive agent may include conductive agents conventionally used in the art, for example, the conductive agent is selected from at least one of Super P, acetylene black, or Keqin black.

The binder may include binders conventionally used in the art, for example, the binder is selected from at least one of sodium carboxymethyl cellulose, carboxymethyl cellulose, polyvinylidene fluoride, or styrene-butadiene rubber.

Based on a total weight of the negative electrode coating layer, a content of the negative electrode material may range from 80% to 99% (for example, 80%, 81%, 82%, 83%, 84%, 85%, 86%, 87%, 88%, 89%, 90%, 91%, 92%, 93%, 94%, 95%, 96%, 97%, 98%, or 99%), a content of the conductive agent may range from 0.5% to 10% (for example, 10%, 9%, 8%, 7%, 6%, 5%, 4%, 3%, 2%, 1%, or 0.5%), and a content of the binder may range from 0.5% to 10% (for example, 10%, 9%, 8%, 7%, 6%, 5%, 4%, 3%, 2%, 1%, or 0.5%).

In an example, based on the total weight of the negative electrode coating layer, the content of the negative electrode material ranges from 95% to 99%, the content of the conductive agent ranges from 0.5% to 2.5%, and the content of the binder ranges from 0.5% to 2.5%.

In an example, based on the total weight of the negative electrode coating layer, the content of the negative electrode material ranges from 96% to 98%, the content of the conductive agent ranges from 1% to 2%, and the content of the binder ranges from 1% to 2%.

A third aspect of the present disclosure provides a battery, which includes the negative electrode material according to the first aspect of the present disclosure and/or the negative electrode plate according to the second aspect of the present disclosure.

Components of the battery other than the negative electrode plate (for example, a positive electrode plate, a separator, an electrolyte solution, and so on) can be conventional choices in the art.

In the present disclosure, the battery further includes a positive electrode plate.

In an example, the positive electrode plate includes a positive electrode current collector and a positive electrode active material layer coated on at least one side of the positive electrode current collector. The positive electrode active material layer includes a positive electrode active material.

The positive electrode active material can be a conventional choice in the art, for example, the positive electrode active material is selected from at least one of lithium cobalt oxide (LCO), nickel cobalt manganese ternary material (NCM), nickel cobalt aluminum ternary material (NCA), nickel cobalt manganese aluminum quaternary material (NCMA), lithium ferrous phosphate (LFP), lithium manganese phosphate (LMP), lithium vanadium phosphate (LVP), lithium manganate (LMO), lithium nickel oxide, lithium nickel manganese binary material, lithium-rich manganese-based material, or lithium manganese ferrous phosphate.

The positive electrode active material may further include doped and/or coated positive electrode active materials.

The assembly method of the battery can be carried out in a conventional manner in the art.

The battery can be a liquid electrolyte solution battery, a semi-solid-state battery, or a full solid-state battery.

It should be noted that numerical expressions such as “first” and “second” in the present disclosure are only used to distinguish between different objects or usages, and do not represent a difference in order.

The following describes the present disclosure in detail by using embodiments. The embodiments described in the present disclosure are merely some, but not all of the embodiments of the present disclosure. All other embodiments obtained by a person of ordinary skill in the art based on the embodiments of the present disclosure without creative efforts fall within the protection scope of the present disclosure.

In the following examples, unless otherwise specified, all materials used were commercially available analytical reagents.

The following examples are used to illustrate the battery of the present disclosure.

### Example 1

### (1) Preparation of a Silicon-Carbon Particle

S1. Corn starch was frozen in liquid nitrogen, then placed in a vacuum freeze dryer for freeze-drying, where a freeze-drying temperature is −40° C. and a freeze-drying time is 12 h, to obtain corn starch powder;
S2. The corn starch powder obtained in step S1 was placed in a high-temperature furnace and sintered for 4 h under a nitrogen atmosphere, with a sintering temperature of 900° C. and a heating rate of 5° C./min, to obtain porous carbon;
S3. The porous carbon obtained in step S2 was crushed, 0.5 kg was taken and sieved through a 200-mesh sieve, then placed in a rotary tube furnace for vapor deposition of silicon material, with a rotation speed of 1 r/min. High-purity nitrogen was introduced at a flow rate of 3 L/min. The mixture was heated to 550° C. at a heating rate of 5° C./min, while maintaining the nitrogen flow rate, 99.99% pure silane was introduced at a flow rate of 2.0 L/min, and silane was introduced for 1 h;
S4. The material obtained in step S3 was spray granulated, sieved through a 500-mesh sieve, then placed in a CVD furnace for carbon coating. High-purity nitrogen was introduced, and the material was heated to 900° C. at a heating rate of 5° C./min; then 99.99% pure acetylene was introduced with an acetylene to nitrogen flow ratio of 1:1. The gas was introduced for 3 h. The obtained material was sieved through a 500-mesh sieve and performed demagnetization treatment to obtain the silicon-carbon particle, where the demagnetization treatment was performed in an electromagnetic powder demagnetizer;

### (2) Preparation of a Negative Electrode Plate

The silicon-carbon particle obtained in step (1), conductive carbon black, and styrene-butadiene rubber were mixed in a mass ratio of 95:2:3, deionized water was added; the mixture was stirred and sieved through a 200-mesh sieve to obtain a negative electrode slurry with a solid content of 45 wt %; the above negative electrode slurry was coated onto a copper foil using a transfer coater, and the coated copper foil was dried at 120° C., followed by roll pressing, to obtain the negative electrode plate;

### (3) Preparation of a Positive Electrode Plate

Lithium cobalt oxide, carbon nanotubes, acetylene black, and polyvinylidene fluoride were mixed in a mass ratio of 96:1.2:1.5:1.3 in a mixing tank, N-methylpyrrolidone was added; the mixture was stirred and sieved through a 200-mesh sieve to obtain a positive electrode slurry with a solid content of 75 wt %, the above positive electrode slurry was coated onto an aluminum foil using a coater, and the coated aluminum foil was dried at 120° C., followed by roll pressing, to obtain the positive electrode plate;

### (4) Preparation of a Battery

The negative electrode plate obtained in step (2), the positive electrode plate obtained in step (3), and a separator (polyethylene film) were wound to form a jelly roll (width of 62 mm), the jelly roll was packaged with an aluminum-plastic film and baked to remove moisture, then an electrolyte solution (1.0 mol/L LiPF₆, with an organic solvent being ethylene carbonate (EC), diethyl carbonate (DEC), and ethyl methyl carbonate (EMC) mixed in a mass ratio of 2:1:2) was injected, followed by hot pressing and formation, to obtain the battery.

For Examples 2 to 6 and Comparative Example 2, reference was made to Example 1. A difference lies in that the silicon-carbon particle are changed by altering the parameters of the silicon-carbon particle preparation process, and details are shown in Table 1, where a median particle size Dv50 of silicon in Examples 1 to 6 of the present disclosure is within the range of 2 nm-10 nm (including the endpoints), a pore diameter of the porous carbon is within the range of 0.01 nm-10 nm (including the endpoints), and a silicon in the silicon-carbon particle is an amorphous silicon.

TABLE 1

| | Mass | | | | | | | |
|---|---|---|---|---|---|---|---|---|
| | content | | | Thickness of | Thickness | | | |
| | of | Radius of | Dv50 of the | the silicon- | of the | Specific | True | |
| | silicon | the cavity | silicon-carbon | carbon layer | coating | surface | density | |
| | ω % | r1 μm | particle μm | μm | layer nm | area m²/g | g/cm³ | a % |
| Example 1 | 13 | 2 | 8 | 2 | 60 | 10.30 | 1.57 | 49.26 |
| Example 2 | 0.7 | 0.5 | 5 | 2 | 50 | 18.41 | 1.20 | 19.61 |
| Example 3 | 80 | 4 | 10 | 1 | 70 | 2.20 | 2.12 | 78.90 |
| Example 4a | 0.08 | 0.1 | 2 | 0.9 | 60 | 22.56 | 1.12 | 9.43 |
| Example 4b | 30 | 8 | 25 | 4.5 | 60 | 9.50 | 1.61 | 63.69 |
| Example 4c | 38 | 10 | 30 | 5 | 60 | 7.43 | 1.69 | 66.40 |
| Example 5 | 13 | 2 | 8 | 2 | 60 | 11.50 | 1.53 | 49.26 |
| Example 6 | 13 | 2.5 | 8 | 1.5 | 60 | 11.20 | 1.53 | 61.58 |
| Comparative | 13 | 1.5 | 8 | 2.5 | 60 | 10.33 | 1.42 | 36.95 |
| Example 2 | | | | | | | | |

### Comparative Example 1

Comparative Example 1 was carried out with reference to Example 1, except that the preparation method of the silicon-carbon particle was different, specifically: silicon and graphite microflakes were mixed in a mass ratio of 0.7:1, and then ball-milled to obtain a mixed powder, with a ball-milling rate of 400 r/min and a ball-milling time of 2 h; the above mixed powder, glucose, 2,4,6-trifluorotriazine, and cetyltrimethylammonium bromide (CTAB) were mixed, where a mass ratio of the mixed powder to glucose was 1:11, a mass ratio of the mixed powder to 2,4,6-trifluorotriazine was 20:1, and a mass ratio of the mixed powder to CTAB was 1300:1; after oscillating and shaking, ultrasonic dispersion was performed, followed by a hydrothermal reaction with a filling ratio of 60%, a reaction temperature of 220° C., and a reaction time of 10 h, to obtain a mixed suspension; the mixed suspension was centrifuged and dried to obtain a solid material; the solid material was calcined in an argon atmosphere for 7 h at a calcination temperature of 750° C. to obtain a silicon-carbon material, where a median particle size Dv50 of the silicon-carbon material was 7.8 μm, a specific surface area was 3.5 m²/g, and a true density was 1.65 g/cm³.

### Test Example

### (1) Silicon-Carbon Particle Conductivity Test

The silicon-carbon particle prepared in the examples and the silicon-carbon material prepared in the comparative examples were subjected to conductivity test, and the results were recorded in Table 2.

### (2) SEM Test

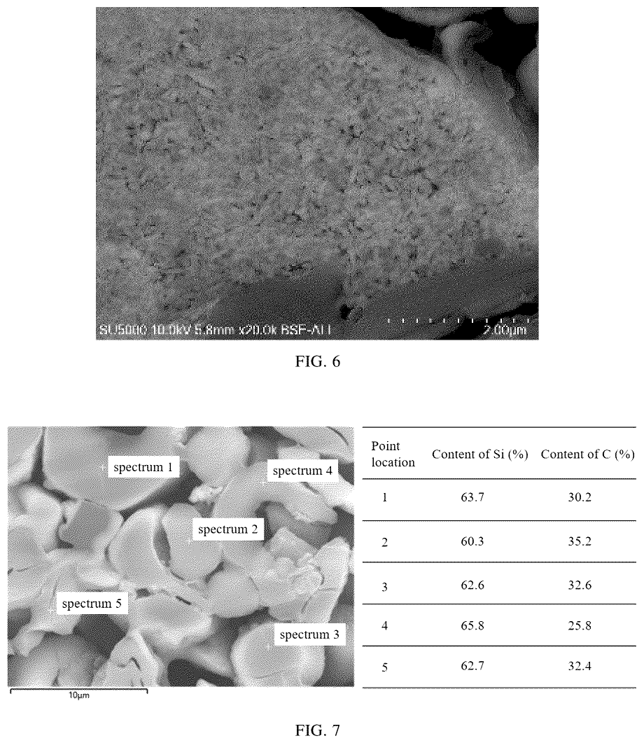

The silicon-carbon particle prepared in Example 1 and the silicon-carbon material prepared in Comparative Example 1 were subjected to SEM tests, where a SEM image of the silicon-carbon particles prepared in Example 1 is shown in FIG. 5. It can be seen from FIG. 5 that the silicon-carbon particles have hollow structures, and the distribution of silicon and carbon in the silicon-carbon layer is very uniform; a SEM image of the silicon-carbon material prepared in Comparative Example 1 is shown in FIG. 6. It can be seen from FIG. 6 that the distribution of silicon and carbon is uneven.

### (3) Energy Spectrum Element Distribution Analysis Test-Point Scan Test

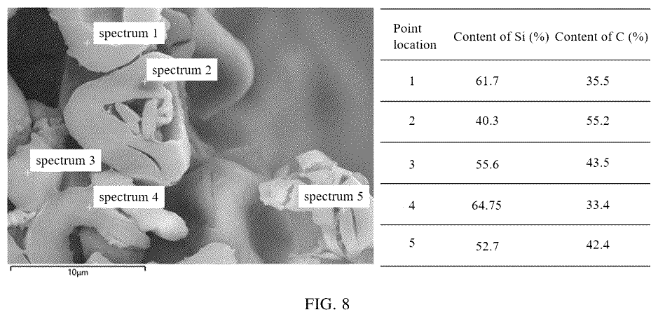

The silicon-carbon particles prepared in Example 1 and Example 5 were subjected to energy spectrum element distribution analysis test-point scan test, and the test results were shown in FIG. 7 and FIG. 8, where FIG. 7 is a point scan result of the energy spectrum element distribution pattern of silicon-carbon particles prepared in Example 1, and FIG. 8 is a point scan result of the energy spectrum element distribution pattern of silicon-carbon particles prepared in Example 5; it can be seen from the figures that in Example 1,

$$\vert \frac{{m}_{n} - {m}_{0}}{{m}_{0}} \vert \times 100 \%$$

is about 24.7%, and in Example 5,

$$\vert \frac{{m}_{n} - {m}_{0}}{{m}_{0}} \vert \times 100 \%$$

is about 47%, where in FIG. 7 and FIG. 8, “spectrum 1” denotes “point location 1”, with this naming convention extending in sequence such that “spectrum 2” represents “point location 2”.

### (4) Specific Capacity Test

The silicon-carbon particles prepared in the examples and the silicon-carbon materials prepared in the comparative examples were added with conductive carbon black and styrene-butadiene rubber, where a mass ratio of the silicon-carbon particles/silicon-carbon material, conductive carbon black, and styrene-butadiene rubber was 97:1:2, and deionized water was added; the mixture was stirred and sieved through a 200-mesh sieve to obtain a negative electrode slurry with a solid content of 45 wt %. The negative electrode slurry was coated onto a copper foil using a transfer coater, and the coated copper foil was dried at 120° C., followed by rolling, to obtain a negative electrode plate, which was subjected to lithium half-cell testing. The specific test method was as follows: 0.05C constant current discharging was performed till 5 mV was reached, standing was performed for 10 min, 0.025C constant current discharging was performed till 5 mV was reached; then 0.05 C constant current charging was performed till 1.5 V was reached, and the test results were recorded in Table 2.

### (5) Capacity Retention Rate Test

The batteries prepared in the examples and the comparative examples were placed in an environment of 25° C., then charged to 4.45 V at a constant current of 1 C and a constant voltage, where a cut-off current was 0.05 C. The battery was left aside for 15 min, and then discharged at a current of 1 C to 3 V. An initial capacity was recorded as Q1; when a number of cycles reached 500, a capacity was recorded as Q2. The calculation formula used is as follows.

Capacity retention rate (%)=Q2/Q1×100%, and the test results were recorded in Table 2.

### (6) Energy Density Test

The batteries prepared in the examples and the comparative examples were placed in an environment of 25° C., charged to 4.45 V at a constant current of 0.5 C and a constant voltage, where a cut-off current was 0.05 C. The battery was left aside for 10 min, and then discharged to 3.0 V at 0.2 C, to obtain a discharge capacity. Energy density=discharge capacity×Average voltage/(Thickness×Width×Height), and the test results were recorded in Table 2.

### (7) Rate Performance Test

Rate performance tests were performed on batteries prepared in the examples and comparative examples, and specific test methods were as follows:
1. standing at 25° C.±5° C. for 10 min;
2. discharging at 0.2 C to a lower limit voltage of 3.0 V;
3. standing for 10 min;
4. charging at 0.7 C to an upper limit voltage of 4.45 V in a constant temperature room, with a cut-off current of 0.025 C;
5. standing for 10 min;
6. discharging at a specific rate (discharge rate: 0.2 C/1 C/2 C/3 C/4 C) to the lower limit voltage in a constant temperature room or a constant temperature box;
7. standing for 10 min.

Steps 4 to 7 were repeated until all rate discharge tests were completed, and test results were recorded in Table 2.

### (8) Expansion Rate Test

Expansion rate tests were performed on batteries prepared in the examples and comparative examples, the specific methods were as follows:

Under a condition of 25° C., the battery was charged to 4.45 V at a constant current of 1 C and charged to a cut-off current was 0.05 C at a constant voltage of 4.45 V. The battery was left aside for 15 min, and then discharged to 3 V at 1 C. A PPG thickness tester was used to test a thickness of the battery after the first full charge and a thickness after the 100^{th} cycle full charge. The expansion rate=(The thickness of the batter after 100^{th} cycle full charge−The thickness of the battery after the first full charge)/The thickness of the battery after the first full charge, and the results were recorded in Table 2.

TABLE 2

| | | | | | Rate | |
|---|---|---|---|---|---|---|
| | | | 100^{th} | | performance (4 | |
| | | Specific | capacity | Energy | C discharge | |
| | Conductivity | Capacity | retention | density | capacity | Expansion |
| | S/cm | mAh/g | rate % | Wh/L | retention) % | Rate % |
| Example 1 | 104.7 | 703.20 | 87.1 | 753 | 85.4 | 6.1 |
| Example 2 | 243.4 | 378.48 | 89.4 | 689 | 87.4 | 5.7 |
| Example 3 | 24.9 | 2472.00 | 45.1 | 930 | 60.2 | 7.9 |
| Example 4a | 312.5 | 362.11 | 91.6 | 670 | 90.1 | 5.3 |
| Example 4b | 76.8 | 1152.00 | 74.5 | 820 | 67.5 | 7.2 |
| Example 4c | 65.3 | 1363.20 | 70.3 | 884 | 65.7 | 7.5 |
| Example 5 | 97.1 | 692.10 | 75.1 | 737 | 75.2 | 7.4 |
| Example 6 | 101.2 | 698.30 | 86.6 | 748 | 84.7 | 6.2 |
| Comparative | 1.03 | 1312.30 | 37.3 | 867 | 54.2 | 9.7 |
| Example 1 | | | | | | |
| Comparative | 102.1 | 689.30 | 84.3 | 742 | 82.1 | 8.3 |
| Example 2 | | | | | | |

As can be seen from Table 2, compared with Comparative Example 1, the battery prepared with the negative electrode material of the present disclosure has significantly improved conductivity, 100^{th} capacity retention rate and rate performance, and significantly reduced expansion rate. The hollow structure of the negative electrode material of the present disclosure significantly improves the cycle performance and rate performance of the battery; compared with Comparative Example 2, Example 1 of the present disclosure meets

$$ω \leq \frac{{a}^{3}}{1.05 \times ( 1 - {a}^{3} )} ,$$

and the capacity retention rate and rate performance of Example 1 are significantly improved, and the expansion rate is significantly reduced.

The preferred Examples of the present disclosure have been described in detail above, but the present disclosure is not limited thereto. Within the technical concept of the present disclosure, various simple modifications can be made to the technical solutions of the present disclosure, including combining various technical features in any other suitable manner. These simple modifications and combinations should also be regarded as the content disclosed by the present disclosure, and all fall within the protection scope of the present disclosure.

What is claimed is:

1. A negative electrode material, comprising a silicon-carbon particle with a hollow structure,
wherein the hollow structure comprises a cavity and a shell surrounding the cavity, the shell comprises a silicon-carbon layer; and
a mass content of silicon in the silicon-carbon particle ω and a ratio of a radius of the cavity to a radius of the silicon-carbon particle a satisfy
$$ω \leq \frac{{a}^{3}}{1.05 \times ( 1 - {a}^{3} )} .$$

2. The negative electrode material according to claim 1, wherein the mass content of silicon in the silicon-carbon particle ω ranges from 0.01% to 90%.

3. The negative electrode material according to claim 2, wherein the mass content of silicon in the silicon-carbon particle ω ranges from 5% to 20%.

4. The negative electrode material according to claim 1, wherein the radius of the cavity ranges from 0.05 μm to 14.5 μm; and/or
the ratio of the radius of the cavity to the radius of the silicon-carbon particle a ranges from 0.3% to 97%.

5. The negative electrode material according to claim 4, wherein the radius of the cavity ranges from 0.5 μm to 4 μm.

6. The negative electrode material according to claim 1, wherein five points are randomly selected on the silicon-carbon layer of the silicon-carbon particle, a ratio of a mass of silicon to a mass of carbon at each point is mₙ, an average value of the ratio of the mass of silicon to the mass of carbon at the five points is m₀, mₙ and m₀ satisfy
$$\vert \frac{{m}_{n} - {m}_{0}}{{m}_{0}} \vert \times 100 \% \leq 50 \% ,$$
and n is 1, 2, 3, 4 or 5.

7. The negative electrode material according to claim 6, wherein
$$\vert \frac{{m}_{n} - {m}_{0}}{{m}_{0}} \vert \times 100 \% \leq 35 \% .$$

8. The negative electrode material according to claim 7, wherein
$$\vert \frac{{m}_{n} - {m}_{0}}{{m}_{0}} \vert \times 100 \% \leq 25 \% .$$

9. The negative electrode material according to claim 1, wherein a carbon in the silicon-carbon particle comprises a porous carbon.

10. The negative electrode material according to claim 9, wherein the porous carbon comprises micropores and/or mesopores; and/or
a pore diameter of the porous carbon ranges from 0.001 nm to 50 nm; and/or
a median particle size Dv50 of the silicon-carbon particle ranges from 2 μm to 30 μm.

11. The negative electrode material according to claim 9, wherein the pore diameter of the porous carbon ranges from 0.01 nm to 10 nm; and/or
the median particle size Dv50 of the silicon-carbon particle ranges from 5 μm to 10 μm.

12. The negative electrode material according to claim 1, wherein a thickness of the silicon-carbon layer ranges from 0.5 μm to 5 μm; and/or
a ratio of the thickness of the silicon-carbon layer to the radius of the silicon-carbon particle ranges from 3% to 98%.

13. The negative electrode material according to claim 1, wherein the thickness of the silicon-carbon layer ranges from 1 μm to 4.5 μm.

14. The negative electrode material according to claim 1, wherein a silicon in the silicon-carbon particle comprises an amorphous silicon; and/or
a median particle size Dv50 of the silicon ranges from 0.01 nm to 150 nm.

15. The negative electrode material according to claim 1, wherein a median particle size Dv50 of a silicon in the silicon-carbon particle ranges from 2 nm to 10 nm; and/or
the shell further comprises a coating layer on the outer surface of the silicon-carbon layer.

16. The negative electrode material according to claim 15, wherein the coating layer comprises a carbon layer; and/or
a thickness of the coating layer ranges from 20 nm to 300 nm; and/or
a ratio of the thickness of the coating layer to the radius of the silicon-carbon particle ranges from 0.1% to 30%.

17. The negative electrode material according to claim 1, wherein a conductivity of the silicon-carbon particle ranges from 10 S/cm to 500 S/cm; and/or
a specific surface area of the silicon-carbon particle ranges from 0.5 m²/g to 25 m²/g; and/or
a true density of the silicon-carbon particle ranges from 1 g/cm³ to 3 g/cm³.

18. The negative electrode material according to claim 17, wherein the conductivity of the silicon-carbon particle ranges from 20 S/cm to 320 S/cm; and/or
the true density of the silicon-carbon particle ranges from 1.1 g/cm³ to 2.2 g/cm³.

19. A negative electrode plate, wherein the negative electrode plate comprises the negative electrode material according to claim 1.

20. A battery, wherein the battery comprises the negative electrode material according to claim 1.
